(19) United States
(12) Patent Application Publication
(10) Pub. No.: US 2025/0151168 A1
(43) Pub. Date: May 8, 2025

(54) METHODS, SYSTEMS, APPARATUSES, AND DEVICES FOR FACILITATING SIGNALING FOR EMERGENCIES

(71) Applicant: Clifford Harold Catlett, Gallatin, TN (US)

(72) Inventor: Clifford Harold Catlett, Gallatin, TN (US)

(21) Appl. No.: 18/790,746

(22) Filed: Jul. 31, 2024

Related U.S. Application Data
(60) Provisional application No. 63/596,446, filed on Nov. 6, 2023.

(51) Int. Cl. H04W 76/50; G08B 5/36

(52) U.S. Cl. CPC H04W 76/50; G08B 5/36

(57) ABSTRACT

Disclosed herein is an apparatus for facilitating signaling for emergencies, in accordance with some embodiments. Accordingly, the apparatus may include a communication device, a processing device, and a lighting source. Further, the communication device may be configured for receiving a first data from a device. Further, the processing device may be communicatively coupled with the communication device. Further, the processing device may be configured for analyzing the first data. Further, the processing device may be configured for determining an emergency based on the analyzing of the first data. Further, the processing device may be configured for generating a first signal based on the determining of the emergency. Further, the lighting source may be operatively coupled with the processing device. Further, the lighting source may be configured for initiating a generation of light with a specified light characteristic based on the first signal.

### FIELD OF THE INVENTION

Generally, the present disclosure relates to the field of data processing. More specifically, the present disclosure relates to methods, systems, apparatuses, and devices for facilitating signaling for emergencies.

### BACKGROUND OF THE INVENTION

The field of data processing is technologically important to several industries, business organizations, and/or individuals. In particular, the use of data processing is prevalent for facilitating signaling for emergencies.

Emergency services are indispensable in modern society. Emergency services include, but are not limited to, the police, the fire department, emergency medical services, etc. In general, emergency services are deployed when a person contacts the emergency services via the appropriate contact method. The emergency services are then deployed to the emergency location. Various technologies have been implemented that reduce the time of emergency service deployment to the emergency location. For example, Global Positioning System (GPS) technology has been implemented that allows firefighters to arrive at the correct location. In addition, GPS technology also allows the emergency services to quickly arrive at the correct location by providing the fastest route to the emergency location. However, GPS technology is not always accurate due to different factors that can cause the emergency services to arrive at the correct location or to fail to locate the emergency location. For example, finding a house in a hidden alleyway or in a dense neighborhood can be difficult, especially in the dark. Therefore, there is a need to help emergency services to more easily find the location of the emergency to provide aid.

Existing techniques for facilitating signaling for emergencies are deficient with regard to several aspects. For instance, current technologies are not consistently accurate in locating a site of an emergency. As a result, different technologies are needed for accurately locating the site of the emergency. Furthermore, current technologies are not precise for locating the site of the emergency in crowded localities. As a result, different technologies are needed to precisely locate the site of the emergency in the crowded localities.

Therefore, there is a need for improved methods, systems, apparatuses, and devices for facilitating signaling for emergencies that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for facilitating signaling for emergencies, in accordance with some embodiments. Accordingly, the apparatus may include a communication device, a processing device, and at least one lighting source. Further, the communication device may be configured for receiving at least one first data from at least one device. Further, the processing device may be communicatively coupled with the communication device. Further, the processing device may be configured for analyzing the at least one first data. Further, the processing device may be configured for determining an emergency based on the analyzing of the at least one first data. Further, the processing device may be configured for generating at least one first signal based on the determining of the emergency. Further, the at least one lighting source may be operatively coupled with the processing device. Further, the at least one lighting source may be configured for initiating a generation of light with at least one specified light characteristic based on the at least one first signal.

Disclosed herein is an apparatus for facilitating signaling for emergencies, in accordance with some embodiments. Accordingly, the apparatus may include a communication device, a processing device, and at least one lighting source. Further, the communication device may be configured for receiving at least one first data from at least one device. Further, the communication device may be configured for receiving at least one configuration data from the at least one device. Further, the processing device may be communicatively coupled with the communication device. Further, the processing device may be configured for analyzing the at least one configuration data. Further, the processing device may be configured for determining at least one specified light characteristic of light based on the analyzing of the at least one configuration data. Further, the processing device may be configured for analyzing the at least one first data. Further, the processing device may be configured for determining an emergency based on the analyzing of the at least one first data. Further, the processing device may be configured for generating at least one first signal based on the determining of the emergency and the determining of the at least one specified light characteristic of the light. Further, the at least one lighting source may be operatively coupled with the processing device. Further, the at least one lighting source may be configured for initiating a generation of the light with the at least one specified light characteristic based on the at least one first signal.

Disclosed herein is an apparatus for facilitating signaling for emergencies, in accordance with some embodiments. Accordingly, the apparatus may include a communication device, a processing device, and at least one lighting source. Further, the communication device may be configured for receiving at least one first data from at least one device. Further, the at least one device may be configured for generating the at least one first data based on an initiation of at least one communication session with at least one external device by the at least one device. Further, the processing device may be communicatively coupled with the communication device. Further, the processing device may be configured for analyzing the at least one first data. Further, the processing device may be configured for obtaining at least one identifier associated with the at least one external device based on the analyzing of the at least one first data. Further, the processing device may be configured for analyzing the at least one identifier of the at least one external device. Further, the processing device may be configured for determining an emergency based on the analyzing of the at least one first data and the analyzing of the at least one identifier. Further, the processing device may be configured for generating at least one first signal based on the determining of the emergency. Further, the at least one lighting source may be operatively coupled with the processing device. Further, the at least one lighting source may be configured for initiating a generation of light with at least one specified light characteristic based on the at least one first signal.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a block diagram of an apparatus 100 for facilitating signaling for emergencies, in accordance with some embodiments.

FIG. 2 is a block diagram of the apparatus 100 for facilitating the signaling for the emergencies, in accordance with some embodiments.

FIG. 3 is a block diagram of the apparatus 100 for facilitating the signaling for the emergencies, in accordance with some embodiments.

FIG. 4 is a block diagram of the apparatus 100 for facilitating the signaling for the emergencies, in accordance with some embodiments.

FIG. 5 is a block diagram of the apparatus 100 for facilitating the signaling for the emergencies, in accordance with some embodiments.

FIG. 6 is a block diagram of the apparatus 100 for facilitating the signaling for the emergencies, in accordance with some embodiments.

FIG. 7 is a block diagram of the apparatus 100 for facilitating the signaling for the emergencies, in accordance with some embodiments.

FIG. 8 is a block diagram of an apparatus 800 for facilitating signaling for emergencies, in accordance with some embodiments.

FIG. 9 is a block diagram of the apparatus 800 for facilitating the signaling for the emergencies, in accordance with some embodiments.

FIG. 10 is a block diagram of the apparatus 800 for facilitating the signaling for the emergencies, in accordance with some embodiments.

FIG. 11 is a block diagram of an apparatus 1100 for facilitating signaling for emergencies, in accordance with some embodiments.

FIG. 12 is a block diagram of an apparatus 1200 for facilitating signaling for emergencies, in accordance with some embodiments.

FIG. 13 is a block diagram of an apparatus 1300 for facilitating signaling for emergencies, in accordance with some embodiments.

FIG. 14 is a flowchart of a method 1400 for facilitating signaling for emergencies, in accordance with some embodiments.

FIG. 15 is a flowchart of a method 1500 for facilitating the signaling for the emergencies, in accordance with some embodiments.

FIG. 16 is a flowchart of a method 1600 for facilitating the signaling for the emergencies, in accordance with some embodiments.

FIG. 17 is an illustration of an online platform 1700 consistent with various embodiments of the present disclosure.

FIG. 18 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating signaling for emergencies, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes a system and method for facilitating immediate response activation of signaling lights during emergency situations. The present disclosure relates generally to emergency systems and home automation. More specifically, the present disclosure discloses an automated system that enables emergency services to find the emergency location more easily.

Further, the present disclosure describes means for emergency services to easily find an emergency location to provide urgent aid. The present disclosure reduces the time emergency services must take to find an emergency location that can be critical in life-threatening emergencies. Another objective of the present disclosure is to provide means to enable the automatic activation of signaling lights. The disclosed apparatus can be implemented to automatically activate residential lights, commercial lights, etc., in a pattern that can be easily detected by the emergency services. Another objective of the present disclosure is to provide means to automatically activate the signaling lights once an emergency call has been made.

Further, the present disclosure describes a system and a method for facilitating immediate response activation of signaling lights during emergency situations. Further, in the event of an emergency, response time is absolutely critical. Even seconds can mean the difference between life and death. To reduce the response time, the present disclosure enables the automatic activation of signaling lights when the user contacts emergency services. For example, when a user dials 911, the system of the present disclosure would automatically activate the outside lights of the residence. This way, the activated lights not only help identify the home that dialed 911, but the activated lights would also alert neighbors that there is an emergency at the residence.

The disclosed system and method enables the use of existing lights in a building as the signaling lights that may be automatically activated. The disclosed system and method may be associated with proprietary light sources that can be remotely activated when the user contacts the emergency services. In addition, the signaling lights may be activated in a specific pattern that helps emergency services determine the emergency location. Further, the present disclosure can include a software application that helps the user pair a computing device with wireless communication capabilities with the one or more signaling lights installed on the building. For example, the software application can include, but is not limited to, a mobile application developed for a smartphone that enables the remote control of smart lights installed on the residence. In other embodiments, different light sources from third parties can also be incorporated into the system to help better indicate the emergency services of the emergency location.

Further, the present disclosure describes a system to facilitate the automatic activation of signaling lights during an emergency so that emergency services can easily determine the emergency location. The system includes a plurality of signaling lights, at least one transceiver, and a corresponding user Personal Computing (PC) device. The plurality of signaling lights corresponds to the several light sources installed on the target structure. For example, the plurality of signaling lights can include existing lights of a building, such as the porch lights of a house. The plurality of signaling lights can also be different types of light sources including, but not limited to, house light bulbs, smart lights, etc. The at least one transceiver corresponds to the mechanism that allows for the remote automatic activation of the plurality of signaling lights. For example, the at least one transceiver can be a wireless router that transmits the activation signal from the corresponding user PC device to the plurality of signaling lights. The corresponding user PC device can include any computing device with wireless communication capabilities including, but not limited to, smartphones.

In some embodiments, the present disclosure describes a software application that enables the user to configure the automatic operation of the plurality of signaling lights. The software application can be developed for specific computing devices. For example, the software application can be provided as a mobile application for smartphones or tablet computers, a desktop application for desktop computers, etc. The software application can include various configuration settings that allow the user to configure the automatic configuration of the system of the present disclosure. For example, the software application can allow the user to pair the plurality of signaling lights to the corresponding user PC device. The software application can also enable the user to configure the operation of the plurality of signaling lights, such as selecting the lighting pattern of the plurality of signaling lights. In addition, the software application can access the communication services of the corresponding user PC device to detect when the user has contacted emergency services automatically. In other embodiments, the software application can enable the pairing of different signaling devices with the corresponding user PC device.

The automation of the system disclosed in the present disclosure enables users to be confident that emergency services can quickly find the emergency location to reduce emergency response times. The overall process of the method of the present disclosure begins with the user installing the corresponding software application on the corresponding user PC device. The user can install the software application from the appropriate application platform compatible with the corresponding user PC device. Once the user has installed the software application, the user can configure the software application to have access to the communication services of the corresponding user PC device to detect when the user has contacted emergency services automatically. In addition, the user can pair the selected plurality of signaling lights to the corresponding user PC device. In the embodiment where smart lights are utilized, the user can pair the corresponding user PC device to each of the smart lights directly via the building's network. In the embodiment where normal light sources are utilized, the at least one transceiver can be implemented to control the power feed to the light sources so that the light sources can be automatically engaged when the user has contacted emergency services.

Once the plurality of signaling lights has been paired with the corresponding user PC device, the user communications on the corresponding user PC device are monitored to detect when the user has contacted emergency services. When the user contacts emergency services, the software application generates an activation command signal that is relayed from the corresponding user PC device to the at least one transceiver. From the at least one transceiver, the activation command signal is then relayed to the selected plurality of signaling lights so that each selected signaling light is activated immediately. This way, the plurality of signaling lights has been already activated by the time the user has finished contacting the emergency services so that emergency services can quickly find the emergency location. In addition, the activation of the plurality of signaling lights can alert people near the emergency location of the emergency so that the people can provide assistance if possible. In other embodiments, different signaling mechanisms can also be implemented to help emergency services locate the emergency including, but not limited to, auditory devices such as speakers or alarms. In addition, the system of present disclosure can include proprietary signaling devices that can be installed on the property.

Furthermore, once the emergency services have reached the emergency location or after the emergency has ended, the present disclosure can provide means to deactivate the plurality of signaling lights. The system of present disclosure can allow the user to remotely turn off the lights via the software application on the corresponding user PC device. The software application can display a deactivate function that the user can select to turn off the plurality of signaling lights when desired. When the deactivate function is selected, a deactivation signal is transmitted to the at least one transceiver which then signals the corresponding signaling lights to be deactivated. Furthermore, the present disclosure can also include an automated deactivation function that turns off the plurality of signaling lights after predetermined conditions have been met. For example, the plurality of signaling lights could be set to turn off after a certain period or after emergency services have left the area. In other embodiments, the present disclosure can include other features that further automate the operation of the system of the present disclosure.

Further, the present disclosure describes a smartphone app that a user can download on a device (computing device). Further, the smartphone app may provide access to communicate/control existing connected lighting devices in the house. This will enable the smartphone app to detect an emergency situation (SOS button, dialing 911, etc.) and then control the connected lighting devices through Wi-Fi or other wireless communication.

Further, the present disclosure describes one or more special lighting devices that can function as a regular light source but upon special activation can emit light in a predetermined pattern (e.g. flashing, red/blue colored lights, signaling SOS in Morse code, etc.). Further, the one or more special lighting devices may be associated with the smartphone app.

Further, the present disclosure describes a transceiver and a power controller that a user can install in series with any existing lighting device (i.e. conventional, non-connected lighting). Further, the present disclosure describes a smartphone app that can communicate with the transceiver in order to trigger the emergency lighting sequence (limited to flashing and perhaps SOS signaling by Morse code).

Further, the light emitted from lighting devices may or may not be limited to the visual spectrum and can also cover other invisible bands such as Infrared, ultraviolet (UV), and so on, which may be detected by special instruments (installed on emergency provider vehicles).

Further, the present disclosure describes a communication between an online platform and the smartphone apps installed on user devices.

Further, the special lighting device could include a failsafe feature such that it does not depend on the smartphone in order to activate the emergency signaling, and instead can rely on sensors present in the special lighting device itself (e.g. sound sensors to detect distressful sounds, etc.). This could be useful in the event that the smartphone/Wi-Fi hub becomes dysfunctional for any reason in an emergency. Further, the special lighting device transmits/receives cues to another special lighting device independent of the Wi-Fi or the smartphone app. Further, the special lighting device includes a power storage (e.g. capacitor, or battery) to provide the emergency lighting signal independent of the power situation.

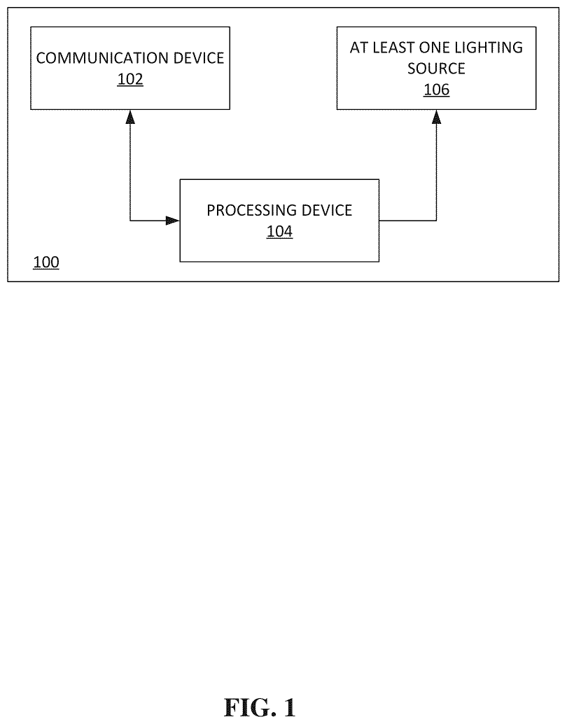

FIG. 1 is a block diagram of an apparatus 100 for facilitating signaling for emergencies, in accordance with some embodiments. Accordingly, the apparatus 100 may include a communication device 102, a processing device 104, and at least one lighting source 106. Further, the apparatus 100 may include a special lighting device. Further, the apparatus 100 may be configured to be installed in at least one building, at least one structure, at least one location, etc.

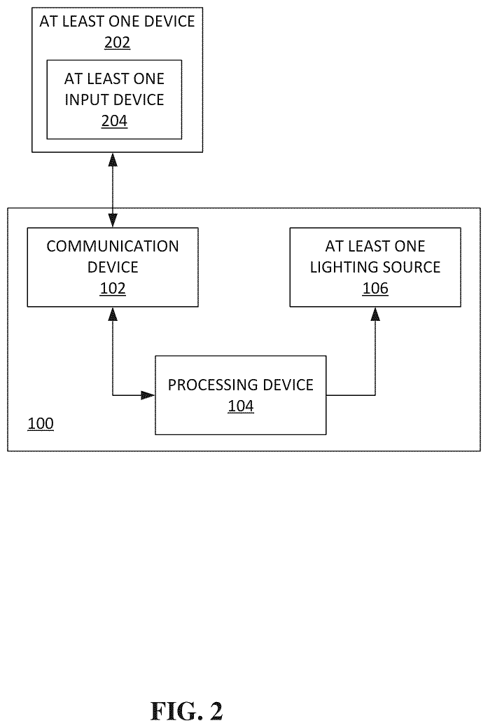

Further, the communication device 102 may be configured for receiving at least one first data from at least one device 202, as shown in FIG. 2. Further, the communication device 102 may include a transceiver, a communication interface, a network interface, etc. Further, the at least one first data may include call information, distress information, activation information, etc. Further, the at least one device 202 may include a smartphone, a sensor, a phone, a button, a user (personal computing) PC device, etc.

Further, the processing device 104 may be communicatively coupled with the communication device 102. Further, the processing device 104 may be configured for analyzing the at least one first data. Further, the at least one first data may be analyzed to identify an outgoing call initiation request, a call recipient identifier, a distress, an activation instance, etc. Further, the processing device 104 may be configured for determining an emergency based on the analyzing of the at least one first data. Further, the emergency may include a fire incident, an earthquake incident, a public order incident, a hazardous material incident, etc. Further, the determining of the emergency makes a location of the apparatus 100 a site of the emergency. Further, the determining of the emergency may be based on the outgoing call initiation request, the call recipient identifier, the distress, the activation instance, etc. Further, the emergency may include at least one emergency situation. Further, the processing device 104 may be configured for generating at least one first signal based on the determining of the emergency. Further, the processing device 104 may include a controller (such as a PWM (pulse width modulation) controller, a DALI (Digital Addressable Lighting Interface) Controller, a DMX (Digital Multiplex) Controller, etc.). Further, the at least one first signal may include at least one first electrical signal with at least one first electrical signal characteristic. Further, the at least one first electrical signal may correspond to the at least one lighting source 106. Further, the at least one first electrical signal may include one or more electrical pulses. Further, the at least one first electrical signal characteristic may include a waveform, a frequency, a pulse width, a duty cycle, a voltage/current level, a duration of pulses, etc. Further, the at least one first signal may include may include at least one digital signal.

Further, the at least one lighting source 106 may be operatively coupled with the processing device 104. Further, the at least one lighting source 106 may include a signaling light. Further, the at least one lighting source 106 may be configured for initiating a generation of light with at least one specified light characteristic based on the at least one first signal. Further, the generation of the light may be emitting the light, producing the light, etc. Further, the at least one specified light characteristic may correspond to the at least one first electrical signal characteristic. Further, the at least one lighting source 106 may include an incandescent bulb, a fluorescent tube, a light emitting diode (LED), a halogen lamp, a high-intensity discharge lamp, a neon tube, etc. Further, the at least one specified light characteristic may include a specific intensity of the light, a specific color of the light, a specific wavelength of the light, a specific pattern of the light, a specific pattern of a plurality of colors of the light, etc. Further, the at least one lighting source 106 may be configured for generating the light with a predefined light characteristic. Further, the at least one lighting source 106 may be electrically powered. Further, the predefined light characteristic may include a predefined intensity of the light, a predefined color of the light, a predefined wavelength of the light, a predefined pattern (Morse code pattern) of the light, a predefined pattern of a plurality of colors (alternation between the plurality of colors) of the light, etc. Further, the predefined light characteristic may not include the predefined pattern of the light and the predefined pattern of the plurality of colors of the light. Further, the generating the light with the predefined light characteristic may be based on a signal generated by the processing device 104. Further, the signal may include an electrical signal with an electrical signal characteristic. Further, the electrical signal characteristic corresponds to the predefined light characteristic. Further, the at least one lighting source 106 may include a lighting fixture compatible with the DALI controller, DMX controller, etc.

Further, in some embodiments, the at least one device 202 may include at least one input device 204, as shown in FIG. 2. Further, the at least one input device 204 may be configured for generating the at least one first data based on receiving at least one input from at least one user. Further, the at least one input device 204 may include a keypad device, an SOS button, a microphone, a touch screen, etc. Further, the at least one input may include a button press, a keyword, a touch gesture, etc.

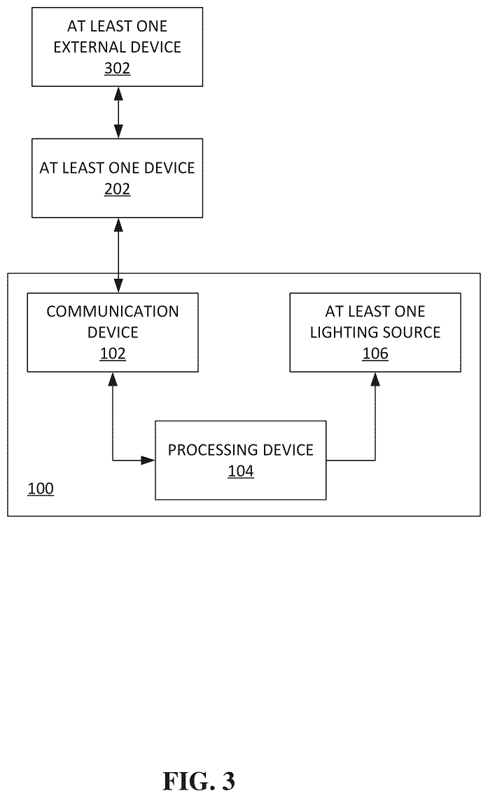

Further, in some embodiments, the at least one device 202 may be configured for generating the at least one first data based on an initiation of at least one communication session with at least one external device 302, as shown in FIG. 3, by the at least one device 202. Further, the initiation of at least one communication session may include an initiation of a phone call. Further, the at least one external device 302 may be associated with at least one emergency service. Further, the at least one external device 302 may include an external communication device, an external server, a telecommunication device, a phone device, a smartphone, etc. Further, the at least one communication session may include a call session, a chat session, a video call session, a VoIP (voice over internet protocol) session, etc. Further, the at least one first data may include at least one communication session data. Further, the at least one communication session data may include at least one content, participant's (caller and recipient) identifiers, a communication session establishing indication, a communication session terminating indication, etc.

Further, in an embodiment, the processing device 104 may be configured for obtaining at least one identifier associated with the at least one external device 302 based on the analyzing of the at least one first data. Further, the at least one identifier may include a phone number, a uniform resource locator (URL), an IMEI (International Mobile Equipment Identity) number, a MAC Address (Media Access Control Address), an IP (internet protocol) address, a UUID (Universally Unique Identifier), etc. Further, the processing device 104 may be configured for analyzing the at least one identifier of the at least one external device 302. Further, the analyzing of the at least one identifier may include detecting a presence of at least one feature in the at least one identifier. Further, the at least one feature may include a keyword, a character sequence, etc. Further, the determining of the emergency may be based on the analyzing of the at least one identifier.

Further, in some embodiments, the communication device 102 may be configured for receiving at least one second data from the at least one device 202. Further, the at least one second data may be associated with a management of the emergency. Further, the processing device 104 may be configured for analyzing the at least one second data. Further, the processing device 104 may be configured for determining a resolution of the emergency based on the analyzing of the at least one second data. Further, the processing device 104 may be configured for generating at least one second signal based on the resolution of the emergency. Further, the at least one second signal may include the electrical signal with the electrical signal characteristic. Further, the at least one lighting source 106 may be configured for terminating the generation of the light with the at least one specified light characteristic based on the at least one second signal. Further, the terminating the generation of the light with the at least one specified light characteristic may include termination of the signaling.

Further, in some embodiments, the processing device 104 may be configured for obtaining at least one condition data associated with at least one condition associated with the emergency. Further, at least one condition may include a duration of time, a presence of one or more emergency service providers, etc. Further, the processing device 104 may be configured for analyzing the at least one condition data based on at least one predetermined condition. Further, the at least one predetermined condition may include a predefined duration of time, a leaving of the one or more emergency service providers, etc. Further, the processing device 104 may be configured for determining a fulfillment of the at least one predetermined condition by the at least one condition based on the analyzing of the at least one condition data. Further, the processing device 104 may be configured for generating at least one second signal based on the fulfillment of the at least one predetermined condition. Further, the at least one lighting source 106 may be configured for terminating the generation of the light with the at least one specified light characteristic based on the at least one second signal.

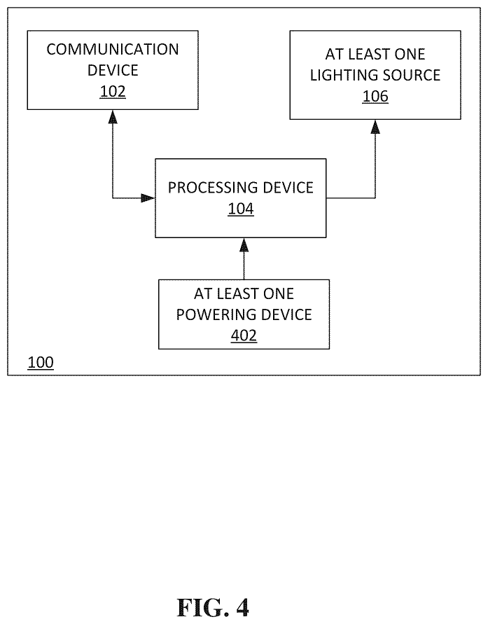

Further, in some embodiments, the apparatus 100 may include at least one powering device 402, as shown in FIG. 4, electrically coupled with the processing device 104. Further, the at least one powering device 402 may include a battery, a capacitor, etc. Further, the at least one powering device 402 may be configured for powering the processing device 104. Further, the generating of the at least one signal may be based on the powering.

Further, in some embodiments, the at least one specified light characteristic may include a belonging of the light to a visible portion of an electromagnetic spectrum of the light. Further, the at least one specified characteristic may include a wavelength of the light. Further, the wavelength of the light for the visible portion of the electromagnetic spectrum may range from 380 nm to 700 nm.

Further, in some embodiments, the at least one specified light characteristic may include a belonging of the light to a non visible portion of an electromagnetic spectrum of the light. Further, the at least one specified characteristic may include a wavelength of the light. Further, the wavelength of the light for the non visible portion of the electromagnetic spectrum may be below 380 nm and above 700 nm.

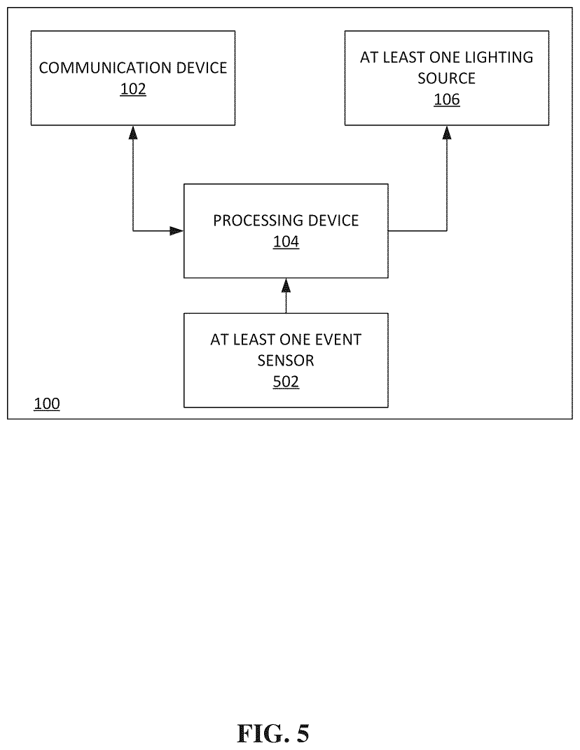

Further, in some embodiments, the apparatus 100 may include at least one event sensor 502, as shown in FIG. 5, communicatively coupled with the processing device 104. Further, the event sensor 502 may include a temperature sensor, a vibration sensor, a pressure sensor, a microphone, an image sensor (camera), etc. Further, the at least one event sensor 502 may be configured for monitoring an environment associated with the apparatus 100 for an event in the environment. Further, the processing device 104 may be configured for generating at least one monitoring data based on the monitoring. Further, the at least one monitoring data may include a temperature reading, a pressure reading, a pressure reading, an audio, a video, etc. Further, the processing device 104 may be configured for analyzing the at least one monitoring data. Further, the processing device 104 may be configured for detecting an occurrence of the event in the environment based on the analyzing of the at least one monitoring data. Further, the event may include an occurrence of fire, a collapse of a building, an occurrence of an earthquake, a call for help, etc. Further, the determining of the emergency may be based on the detecting the occurrence of the event.

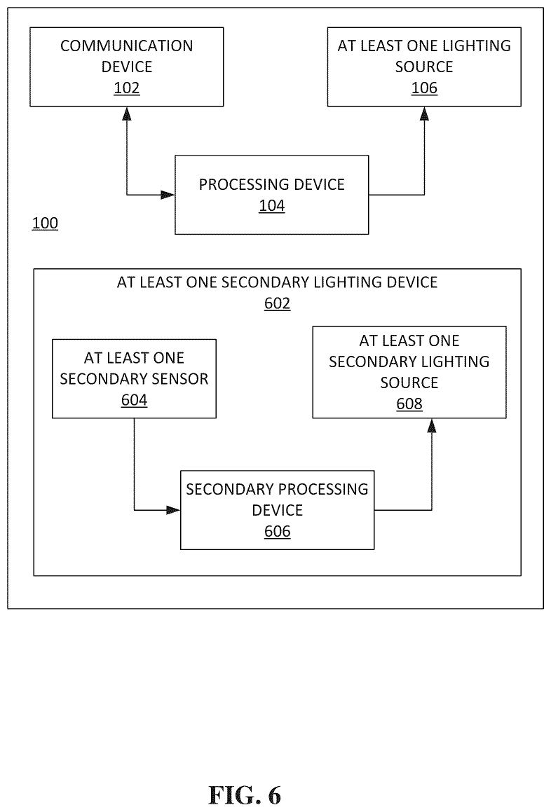

Further, in some embodiments, the apparatus 100 may include at least one secondary lighting device 602, as shown in FIG. 6. Further, the at least one secondary lighting device 602 may include at least one secondary sensor 604, a secondary processing device 606, and at least one secondary light source 608. Further, the at least one secondary sensor 604 may be configured for detecting the light generated by the at least one lighting source 106. Further, the at least one secondary sensor 604 may include a light sensor (such as a photodiode), a light intensity sensor, a light color sensor (such as a color sensor), etc. Further, the secondary processing device 606 may be communicatively coupled with the at least one secondary sensor 604. Further, the secondary processing device 606 may include a controller (such as a PWM (pulse width modulation) controller, a DALI (Digital Addressable Lighting Interface) Controller, a DMX (Digital Multiplex) Controller, etc). Further, the secondary processing device 606 may be configured for generating at least one light data based on the detecting. Further, the secondary processing device 606 may be configured for analyzing the at least one light data. Further, the secondary processing device 606 may be configured for determining at least one light characteristic of the light generated by the at least one lighting source 106 based on the analyzing of the at least one light data. Further, the at least one light characteristic may include an intensity of light, a color of the light, a pattern of lighting, a pattern of a plurality of colors, etc. Further, the secondary processing device 606 may be configured for comparing the at least one light characteristic with the at least one specified light characteristic of the light. Further, the secondary processing device 606 may be configured for generating at least one secondary signal based on the comparing. Further, the at least one secondary light source 608 may be operatively coupled with the secondary processing device 606. Further, at least one secondary light source 608 may include an incandescent bulb, a light emitting diode (LED), etc. Further, the at least one secondary light source 608 may be configured for initiating a generation of light with the at least one specified light characteristic based on the at least one secondary signal. Further, the at least one secondary signal may include the at least one first electrical signal with the at least one first electrical signal characteristic.

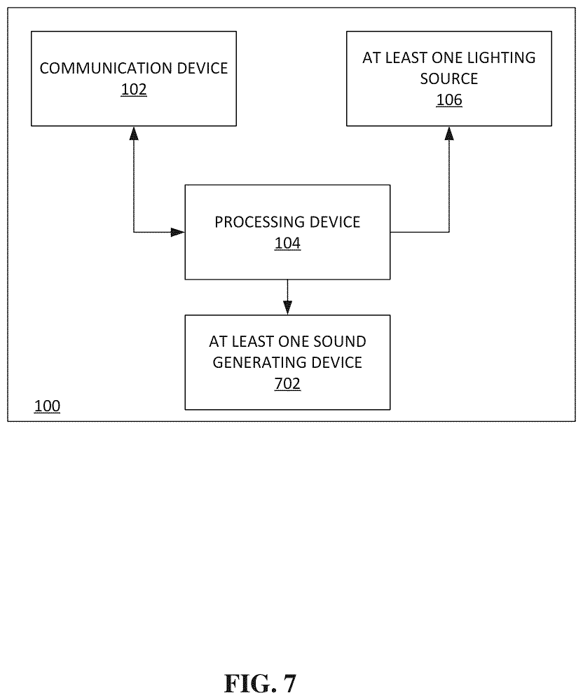

Further, in some embodiments, the apparatus 100 may include at least one sound generating device 702, as shown in FIG. 7, communicatively coupled with the processing device 104. Further, the at least one sound generating device 702 may include a speaker, an ultrasonic speaker, etc. Further, the at least one sound generating device 702 may be configured for initiating a generation of sound with at least one sound characteristic based on the at least one first signal. Further, the at least one sound characteristic may include a pitch of waves of the sound, a wavelength of the waves of the sound, an amplitude of the waves of the sound, a frequency of the waves of the sound, etc.

Further, in some embodiments, the communication device 102 may be configured for receiving at least one configuration data from the at least one device 202. Further, the processing device 104 may be configured for analyzing the at least one configuration data. Further, the processing device 104 may be configured for determining the at least one specified light characteristic of the light based on the analyzing of the at least one configuration data. Further, the generating of the at least one signal may be based on the determining of the at least one specified light characteristic of the light.

FIG. 2 is a block diagram of the apparatus 100 for facilitating the signaling for the emergencies, in accordance with some embodiments.

FIG. 3 is a block diagram of the apparatus 100 for facilitating the signaling for the emergencies, in accordance with some embodiments.

FIG. 4 is a block diagram of the apparatus 100 for facilitating the signaling for the emergencies, in accordance with some embodiments.

FIG. 5 is a block diagram of the apparatus 100 for facilitating the signaling for the emergencies, in accordance with some embodiments.

FIG. 6 is a block diagram of the apparatus 100 for facilitating the signaling for the emergencies, in accordance with some embodiments.

FIG. 7 is a block diagram of the apparatus 100 for facilitating the signaling for the emergencies, in accordance with some embodiments.

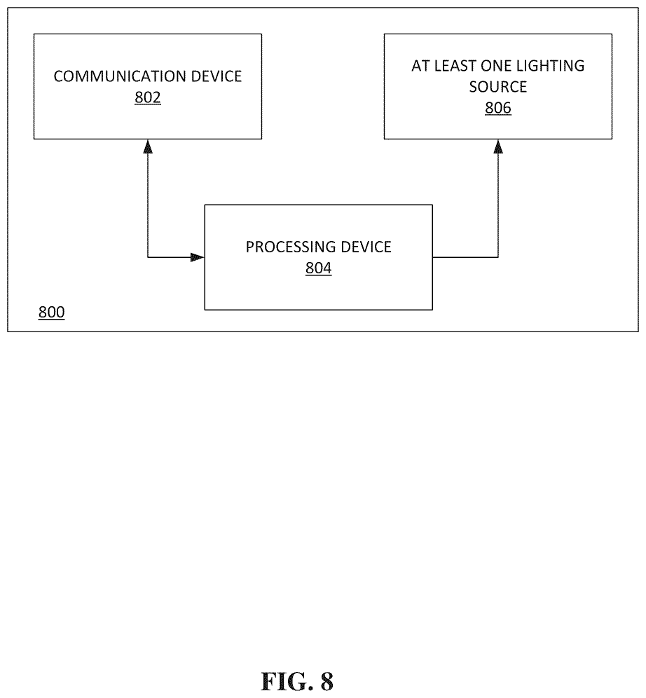

FIG. 8 is a block diagram of an apparatus 800 for facilitating signaling for emergencies, in accordance with some embodiments. Accordingly, the apparatus 800 may include a communication device 802, a processing device 804, and at least one lighting source 806.

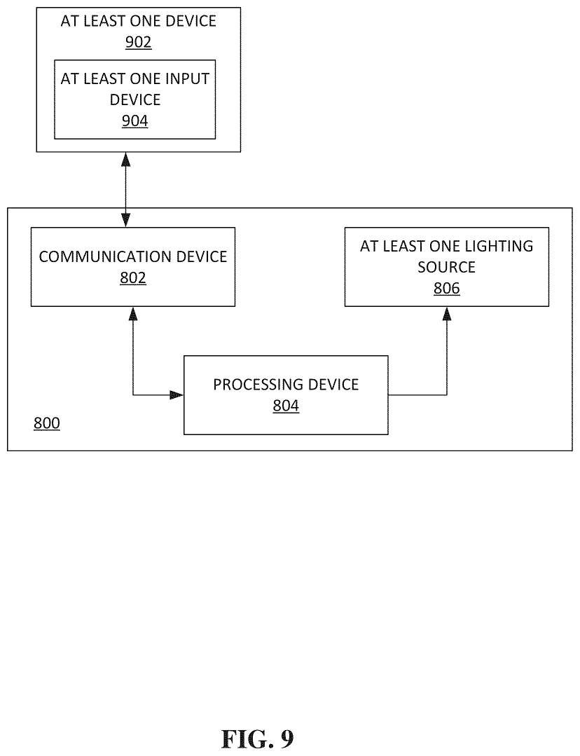

Further, the communication device 802 may be configured for receiving at least one first data from at least one device 902, as shown in FIG. 9. Further, the at least one first data may include a temperature reading, a communication initiation, an SOS signal, etc. Further, the at least one device 902 may include a smartphone, a sensor, etc. Further, the communication device 802 may be configured for receiving at least one configuration data from the at least one device 902. Further, the at least one configuration data may include a pattern of illumination (lighting), a color of the light, an intensity of the light, etc. Further, the processing device 804 may be communicatively coupled with the communication device 802. Further, the processing device 804 may be configured for analyzing the at least one configuration data. Further, the processing device 804 may be configured for determining at least one specified light characteristic of light based on the analyzing of the at least one configuration data. Further, the processing device 804 may be configured for analyzing the at least one first data. Further, the processing device 804 may be configured for determining an emergency based on the analyzing of the at least one first data. Further, the emergency may include a fire hazard, a structural collapse, etc. Further, the processing device 804 may be configured for generating at least one first signal based on the determining of the emergency and the determining of the at least one specified light characteristic of the light.

Further, the at least one lighting source 806 may be operatively coupled with the processing device 804. Further, the at least one lighting source 806 may be configured for initiating a generation of the light with the at least one specified light characteristic based on the at least one first signal.

Further, in some embodiments, the at least one device 902 may include at least one input device 904, as shown in FIG. 9. Further, the at least one input device 904 may include a keypad, an SOS button, etc. Further, the at least one input device 904 may be configured for generating the at least one first data based on receiving at least one input from at least one user.

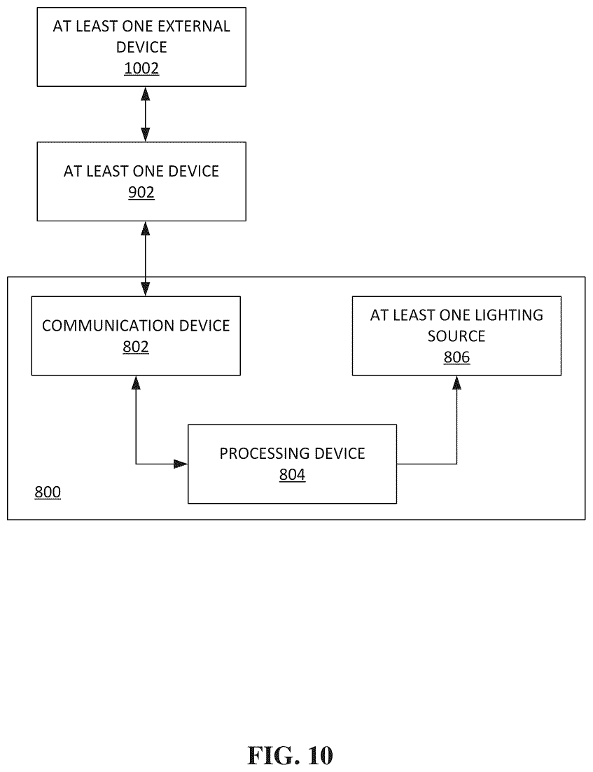

Further, in some embodiments, the at least one device 902 may be configured for generating the at least one first data based on an initiation of at least one communication session with at least one external device 1002, as shown in FIG. 10, by the at least one device 902. Further, the at least one external device 1002 may include a mobile, a phone, a landline, etc.

Further, in an embodiment, the processing device 804 may be configured for obtaining at least one identifier associated with the at least one external device 1002 based on the analyzing of the at least one first data. Further, the at least one identifier may include a name of a website, a phone number, a subscriber identity associated with a subscriber identity module comprised in the at least one external device 1002, etc. Further, the processing device 804 may be configured for analyzing the at least one identifier of the at least one external device 1002. Further, the determining of the emergency may be based on the at least one identifier.

Further, in some embodiments, the communication device 802 may be configured for receiving at least one second data from the at least one device 902. Further, the processing device 804 may be configured for analyzing the at least one second data. Further, the at least one second data may include a temperature reading, a communication initiation, an SOS signal, etc. Further, the processing device 804 may be configured for determining a resolution of the emergency based on the analyzing of the at least one second data. Further, the processing device 804 may be configured for generating at least one second signal based on the resolution of the emergency. Further, the at least one lighting source 806 may be configured for terminating the generation of the light with the at least one specified light characteristic based on the at least one second signal.

Further, in some embodiments, the processing device 804 may be configured for obtaining at least one condition data associated with at least one condition associated with the emergency. Further, the processing device 804 may be configured for analyzing the at least one condition data based on at least one predetermined condition. Further, the at least one predetermined condition may include room temperature, atmospheric pressure, sound under 80 decibels, etc. Further, the processing device 804 may be configured for determining a fulfillment of the at least one predetermined condition by the at least one condition based on the analyzing of the at least one condition data. Further, the processing device 804, may be configured for generating at least one second signal based on the fulfillment of the at least one predetermined condition. Further, the at least one lighting source 806 may be configured for terminating the generation of the light with the at least one specified light characteristic based on the at least one second signal.

FIG. 9 is a block diagram of the apparatus 800 for facilitating the signaling for the emergencies, in accordance with some embodiments.

FIG. 10 is a block diagram of the apparatus 800 for facilitating the signaling for the emergencies, in accordance with some embodiments.

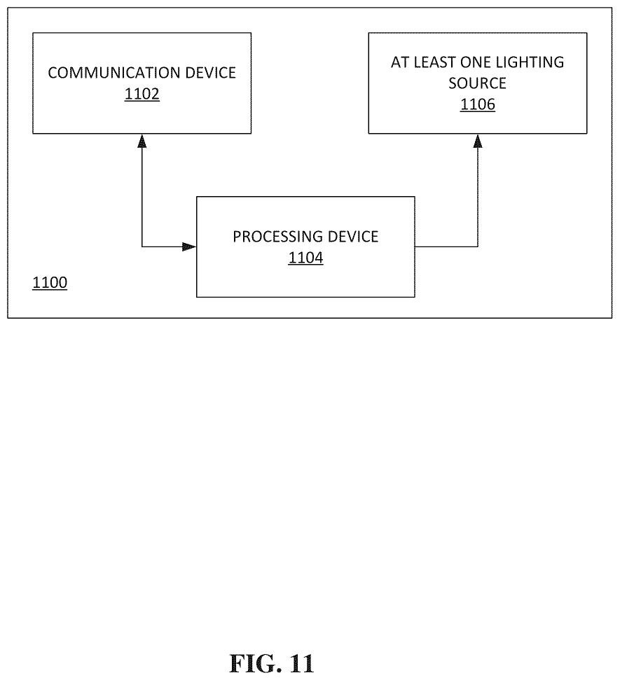

FIG. 11 is a block diagram of an apparatus 1100 for facilitating signaling for emergencies, in accordance with some embodiments. Accordingly, the apparatus 1100 may include a communication device 1102, a processing device 1104, and at least one lighting source 1106.

Further, the communication device 1102 may be configured for receiving at least one first data from at least one device. Further, the at least one first data may include a temperature reading, a communication initiation, an SOS signal, etc. Further, the at least one device may be configured for generating the at least one first data based on an initiation of at least one communication session with at least one external device by the at least one device. Further, the at least one device may include a smartphone, a sensor, etc. Further, the at least one external device may include a smartphone, a keypad, an SOS button, etc.

Further, the processing device 1104 may be communicatively coupled with the communication device 1102. Further, the processing device 1104 may be configured for analyzing the at least one first data. Further, the processing device 1104 may be configured for obtaining at least one identifier associated with the at least one external device based on the analyzing of the at least one first data. Further, the at least one identifier may include a name of a website, a subscriber identity associated with a subscriber identity module, etc. Further, the processing device 1104 may be configured for analyzing the at least one identifier of the at least one external device. Further, the processing device 1104 may be configured for determining an emergency based on the analyzing of the at least one first data and the analyzing of the at least one identifier. Further, the emergency may include a fire hazard, a structural collapse, etc. Further, the processing device 1104 may be configured for generating at least one first signal based on the determining of the emergency.

Further, the at least one lighting source 1106 may be operatively coupled with the processing device 1104. Further, the at least one lighting source 1106 may be configured for initiating a generation of light with at least one specified light characteristic based on the at least one first signal. Further, the at least one specified light characteristic may include an intensity of the light, a color of the light, a pattern of illumination of the light, etc.

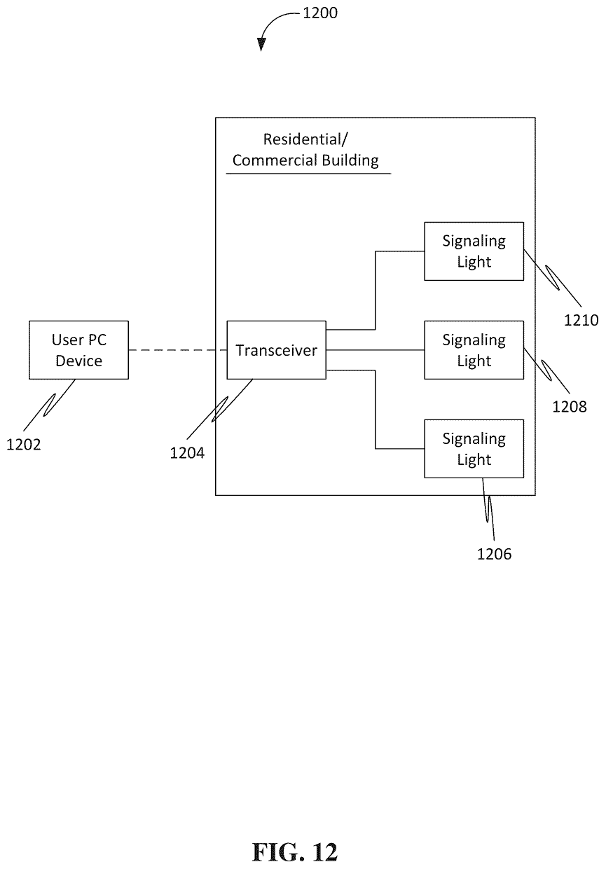

FIG. 12 is a block diagram of an apparatus 1200 for facilitating signaling for emergencies, in accordance with some embodiments. Accordingly, the apparatus 1200 may include a user PC device 1202, a transceiver 1204, and a plurality of signaling lights 1206-1210.

Further, the user PC device 1202 may be configured for generating at least one activation signal. Further, the at least one activation signal may be configured for activating the signaling for emergencies. Further, the user PC device 1202 may include any computing device with wireless communication capabilities including, but not limited to, smartphones.

Further, the transceiver 1204 may be communicatively coupled with the user PC device 1202. Further, the transceiver 1204 may be configured for transmitting the at least one activation signal to the plurality of signaling lights 1206-1210. Further, the transceiver 1204 may be configured for allowing remote activation of signaling for emergencies. Further, the transceiver 1204 may include a wireless router configured for transmitting the at least one activation signal from the user PC device 1202 to the plurality of signaling lights 1206-1210. Further, the plurality of signaling lights 1206-1210 and the transceiver 1204 may be disposed on a residential/commercial building.

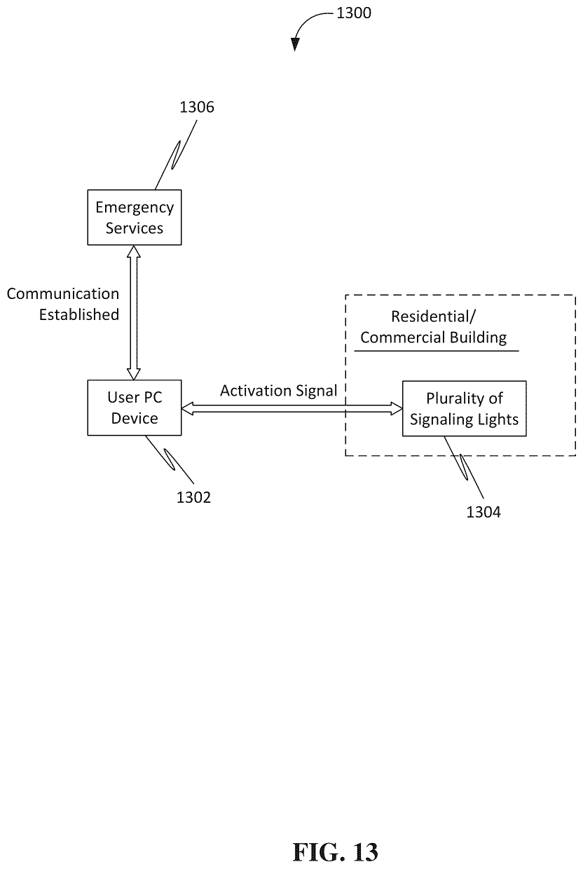

FIG. 13 is a block diagram of an apparatus 1300 for facilitating signaling for emergencies, in accordance with some embodiments. Accordingly, the apparatus 1300 may include a user PC device 1302, a plurality of signaling lights 1304, and a device 1306 associated with emergency services.

Further, the user PC device 1302 may be communicatively coupled with the device 1306 associated with the emergency services. Further, the user PC device 1302 may be configured for establishing a communication with the device 1306 associated with the emergency services. Further, the user PC device 1302 may be configured for generating an activation signal. Further, the activation signal may be configured for activating the signaling.

Further, the plurality of signaling lights 1304 may be communicatively coupled with the user PC device 1302. Further, the plurality of signaling lights 1304 may be configured for receiving the activation signal from the user PC device 1302. Further, the plurality of signaling lights 1304 may be configured for the signaling. Further, the plurality of signaling lights 1304 may be disposed on a residential/commercial building.

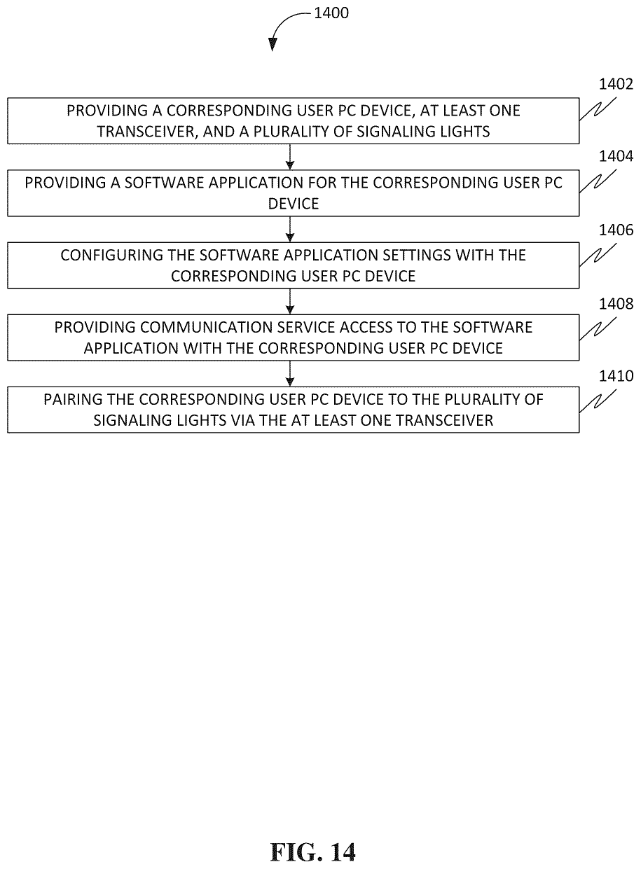

FIG. 14 is a flowchart of a method 1400 for facilitating signaling for emergencies, in accordance with some embodiments. Accordingly, at 1402 the method 1400 may include providing a corresponding user PC device, at least one transceiver, and a plurality of signaling lights.

Further, at 1404 the method 1400 may include providing a software application for the corresponding user PC device.

Further, at 1406 the method 1400 may include configuring the software application settings with the corresponding user PC device.

Further, at 1408 the method 1400 may include providing communication service access to the software application with the corresponding user PC device.

Further, at 1410 the method 1400 may include pairing the corresponding user PC device to the plurality of signaling lights via the at least one transceiver.

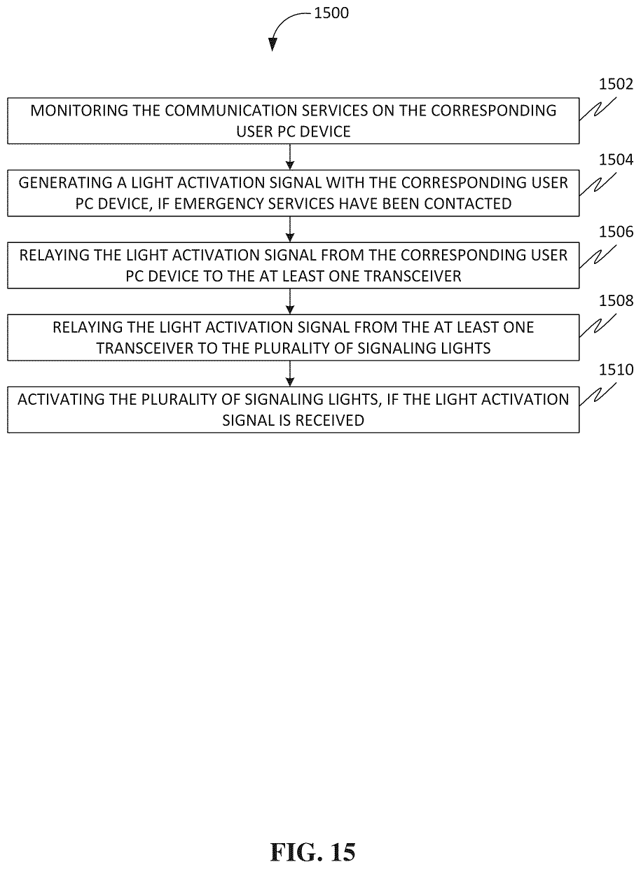

FIG. 15 is a flowchart of a method 1500 for facilitating the signaling for the emergencies, in accordance with some embodiments. Accordingly, at 1502 the method 1500 may include monitoring the communication services on the corresponding user PC device.

Further, at 1504 the method 1500 may include generating a light activation signal with the corresponding user PC device if emergency services have been contacted.

Further, at 1506 the method 1500 may include relaying the light activation signal from the corresponding user PC device to the at least one transceiver.

Further, at 1508 the method 1500 may include relaying the light activation signal from the at least one transceiver to the plurality of signaling lights.

Further, at 1510 the method 1500 may include activating the plurality of signaling lights if the light activation signal is received.

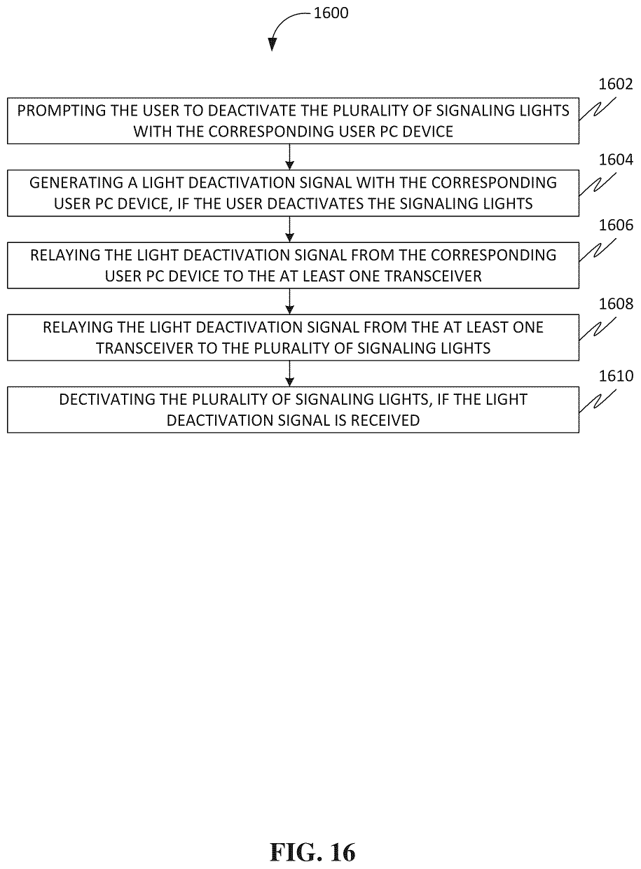

FIG. 16 is a flowchart of a method 1600 for facilitating the signaling for the emergencies, in accordance with some embodiments. Accordingly, at 1602 the method 1600 may include prompting the user to deactivate the plurality of signaling lights with the corresponding user PC device.

Further, at 1604 the method 1600 may include generating a light deactivation signal with the corresponding user PC device, if the user deactivates the signaling lights.

Further, at 1606 the method 1600 may include relaying the light deactivation signal from the corresponding user PC device to the at least one transceiver.

Further, at 1608 the method 1600 may include relaying the light deactivation signal from the at least one transceiver to the plurality of signaling lights.

Further, at 1610 the method 1600 may include deactivating the plurality of signaling lights if the light deactivation signal is received.

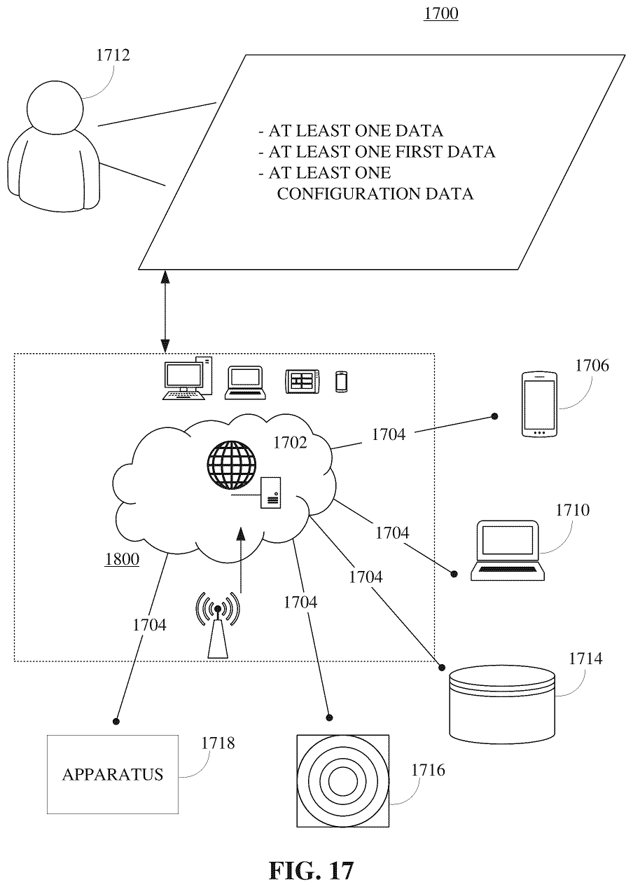

FIG. 17 is an illustration of an online platform 1700 consistent with various embodiments of the present disclosure. By way of non-limiting example, the online platform 1700 to facilitate signaling for emergencies may be hosted on a centralized server 1702, such as, for example, a cloud computing service. The centralized server 1702 may communicate with other network entities, such as, for example, a mobile device 1706 (such as a smartphone, a laptop, a tablet computer, etc.), other electronic devices 1710 (such as desktop computers, server computers, etc.), sensors 1716, an apparatus 1718 (such as the apparatus 100, the apparatus 800, the apparatus 1100, the apparatus 1200, the apparatus 1300, etc.) over a communication network 1704, such as, but not limited to the Internet. Further, users of the online platform 1700 may include relevant parties such as, but not limited to, end-users, administrators, service providers, service consumers, and so on. Accordingly, in some instances, electronic devices operated by the one or more relevant parties may be in communication with the platform.

A user 1712, such as the one or more relevant parties, may access online platform 1700 through a web based software application or browser. The web based software application may be embodied as, for example, but not be limited to, a website, a web application, a desktop application, and a mobile application compatible with a computing device 1800.

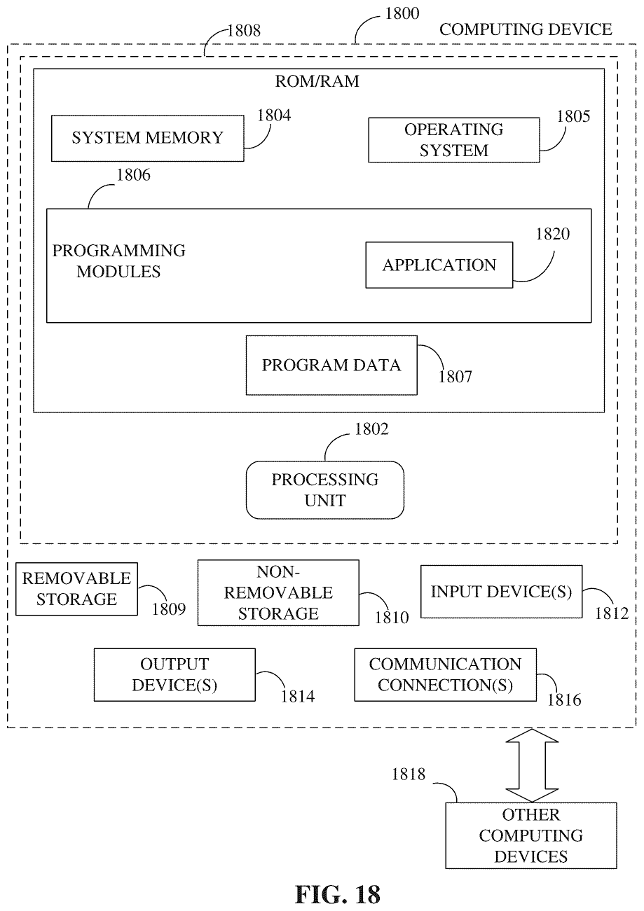

With reference to FIG. 18, a system consistent with an embodiment of the disclosure may include a computing device or cloud service, such as computing device 1800. In a basic configuration, computing device 1800 may include at least one processing unit 1802 and a system memory 1804. Depending on the configuration and type of computing device, system memory 1804 may comprise, but is not limited to, volatile (e.g. random-access memory (RAM)), non-volatile (e.g. read-only memory (ROM)), flash memory, or any combination. System memory 1804 may include operating system 1805, one or more programming modules 1806, and may include a program data 1807. Operating system 1805, for example, may be suitable for controlling computing device 1800's operation. Furthermore, embodiments of the disclosure may be practiced in conjunction with a graphics library, other operating systems, or any other application program and is not limited to any particular application or system. This basic configuration is illustrated in FIG. 18 by those components within a dashed line 1808.

Computing device 1800 may have additional features or functionality. For example, computing device 1800 may also include additional data storage devices (removable and/or non-removable) such as, for example, magnetic disks, optical disks, or tape. Such additional storage is illustrated in FIG. 18 by a removable storage 1809 and a non-removable storage 1810. Computer storage media may include volatile and non-volatile, removable, and non-removable media implemented in any method or technology for storage of information, such as computer-readable instructions, data structures, program modules, or other data. System memory 1804, removable storage 1809, and non-removable storage 1810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1800. Any such computer storage media may be part of device 1800. Computing device 1800 may also have input device(s) 1812 such as a keyboard, a mouse, a pen, a sound input device, a touch input device, a location sensor, a camera, a biometric sensor, etc. Output device(s) 1814 such as a display, speakers, a printer, etc. may also be included. The aforementioned devices are examples and others may be used.

Computing device 1800 may also contain a communication connection 1816 that may allow device 1800 to communicate with other computing devices 1818, such as over a network in a distributed computing environment, for example, an intranet or the Internet. Communication connection 1816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1804, including operating system 1805. While executing on processing unit 1802, programming modules 1806 (e.g., application 1820 such as a media player) may perform processes including, for example, one or more stages of methods, algorithms, systems, applications, servers, databases as described above. The aforementioned process is an example, and processing unit 1802 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. An apparatus for facilitating signaling for emergencies, the apparatus comprising:
a communication device configured for receiving at least one first data from at least one device;
a processing device communicatively coupled with the communication device, wherein the processing device is configured for:
analyzing the at least one first data;
determining an emergency based on the analyzing of the at least one first data; and
generating at least one first signal based on the determining of the emergency; and
at least one lighting source operatively coupled with the processing device, wherein the at least one lighting source is configured for initiating a generation of light with at least one specified light characteristic based on the at least one first signal.

2. The apparatus of claim 1, wherein the at least one device comprises at least one input device, wherein the at least one input device is configured for generating the at least one first data based on receiving at least one input from at least one user.

3. The apparatus of claim 1, wherein the at least one device is configured for generating the at least one first data based on an initiation of at least one communication session with at least one external device by the at least one device.

4. The apparatus of claim 3, wherein the processing device is further configured for:
obtaining at least one identifier associated with the at least one external device based on the analyzing of the at least one first data; and
analyzing the at least one identifier of the at least one external device, wherein the determining of the emergency is further based on the analyzing of the at least one identifier.

5. The apparatus of claim 1, wherein the communication device is further configured for receiving at least one second data from the at least one device, wherein the processing device is further configured for:
analyzing the at least one second data;
determining a resolution of the emergency based on the analyzing of the at least one second data; and
generating at least one second signal based on the resolution of the emergency, wherein the at least one lighting source is configured for terminating the generation of the light with the at least one specified light characteristic based on the at least one second signal.

6. The apparatus of claim 1, wherein the processing device is further configured for:
obtaining at least one condition data associated with at least one condition associated with the emergency;
analyzing the at least one condition data based on at least one predetermined condition;
determining a fulfillment of the at least one predetermined condition by the at least one condition based on the analyzing of the at least one condition data;
generating at least one second signal based on the fulfillment of the at least one predetermined condition, wherein the at least one lighting source is configured for terminating the generation of the light with the at least one specified light characteristic based on the at least one second signal.

7. The apparatus of claim 1 further comprising at least one powering device electrically coupled with the processing device, wherein the at least one powering device is configured for powering the processing device, wherein the generating of the at least one signal is further based on the powering.

8. The apparatus of claim 1, wherein the at least one specified light characteristic comprises a belonging of the light to a visible portion of an electromagnetic spectrum of the light.

9. The apparatus of claim 1, wherein the at least one specified light characteristic comprises a belonging of the light to a non visible portion of an electromagnetic spectrum of the light.

10. The apparatus of claim 1 further comprising at least one event sensor communicatively coupled with the processing device, wherein the at least one event sensor is configured for monitoring an environment associated with the apparatus for an event in the environment, wherein the processing device is further configured for:
generating at least one monitoring data based on the monitoring;
analyzing the at least one monitoring data; and
detecting an occurrence of the event in the environment based on the analyzing of the at least one monitoring data, wherein the determining of the emergency is further based on the detecting of the occurrence of the event.

11. The apparatus of claim 1 further comprising at least one secondary lighting device comprising:
at least one secondary sensor configured for detecting the light generated by the at least one lighting source;
a secondary processing device communicatively coupled with the at least one secondary sensor, wherein the secondary processing device is configured for:
generating at least one light data based on the detecting;
analyzing the at least one light data;
determining at least one light characteristic of the light generated by the at least one lighting source based on the analyzing of the at least one light data;
comparing the at least one light characteristic with the at least one specified light characteristic of the light; and
generating at least one secondary signal based on the comparing; and
at least one secondary light source operatively coupled with the secondary processing device, wherein the at least one secondary light source is configured for initiating a generation of light with the at least one specified light characteristic based on the at least one secondary signal.

12. The apparatus of claim 1 further comprising at least one sound generating device communicatively coupled with the processing device, wherein the at least one sound generating device is configured for initiating a generation of sound with at least one sound characteristic based on the at least one first signal.

13. The apparatus of claim 1, wherein the communication device is further configured for receiving at least one configuration data from the at least one device, wherein the processing device is further configured for:
analyzing the at least one configuration data; and
determining the at least one specified light characteristic of the light based on the analyzing of the at least one configuration data, wherein the generating of the at least one signal is further based on the determining of the at least one specified light characteristic of the light.

14. An apparatus for facilitating signaling for emergencies, the apparatus comprising:
a communication device configured for:
receiving at least one first data from at least one device; and
receiving at least one configuration data from the at least one device;
a processing device communicatively coupled with the communication device, wherein the processing device is configured for:
analyzing the at least one configuration data;
determining at least one specified light characteristic of light based on the analyzing of the at least one configuration data;
analyzing the at least one first data;
determining an emergency based on the analyzing of the at least one first data; and
generating at least one first signal based on the determining of the emergency and the determining of the at least one specified light characteristic of the light; and
at least one lighting source operatively coupled with the processing device, wherein the at least one lighting source is configured for initiating a generation of the light with the at least one specified light characteristic based on the at least one first signal.

15. The apparatus of claim 14, wherein the at least one device comprises at least one input device, wherein the at least one input device is configured for generating the at least one first data based on receiving at least one input from at least one user.

16. The apparatus of claim 14, wherein the at least one device is configured for generating the at least one first data based on an initiation of at least one communication session with at least one external device by the at least one device.

17. The apparatus of claim 16, wherein the processing device is further configured for:
obtaining at least one identifier associated with the at least one external device based on the analyzing of the at least one first data; and
analyzing the at least one identifier of the at least one external device, wherein the determining of the emergency is further based on the at least one identifier.

18. The apparatus of claim 14, wherein the communication device is further configured for receiving at least one second data from the at least one device, wherein the processing device is further configured for:
analyzing the at least one second data;
determining a resolution of the emergency based on the analyzing of the at least one second data; and
generating at least one second signal based on the resolution of the emergency, wherein the at least one lighting source is configured for terminating the generation of the light with the at least one specified light characteristic based on the at least one second signal.

19. The apparatus of claim 14, wherein the processing device is further configured for:
obtaining at least one condition data associated with at least one condition associated with the emergency;
analyzing the at least one condition data based on at least one predetermined condition;
determining a fulfillment of the at least one predetermined condition by the at least one condition based on the analyzing of the at least one condition data; and
generating at least one second signal based on the fulfillment of the at least one predetermined condition, wherein the at least one lighting source is configured for terminating the generation of the light with the at least one specified light characteristic based on the at least one second signal.

20. An apparatus for facilitating signaling for emergencies, the apparatus comprising:
a communication device configured for receiving at least one first data from at least one device, wherein the at least one device is configured for generating the at least one first data based on an initiation of at least one communication session with at least one external device by the at least one device;
a processing device communicatively coupled with the communication device, wherein the processing device is configured for:
analyzing the at least one first data;
obtaining at least one identifier associated with the at least one external device based on the analyzing of the at least one first data;
analyzing the at least one identifier of the at least one external device;
determining an emergency based on the analyzing of the at least one first data and the analyzing of the at least one identifier; and
generating at least one first signal based on the determining of the emergency; and
at least one lighting source operatively coupled with the processing device, wherein the at least one lighting source is configured for initiating a generation of light with at least one specified light characteristic based on the at least one first signal.
